(19) United States
(12) Patent Application Publication
(10) Pub. No.: US 2022/0007227 A1
(43) Pub. Date: Jan. 6, 2022

(54) METHOD FOR RADIO LINK MANAGEMENT, TERMINAL DEVICE, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventors: Zhenshan ZHAO, Dongguan (CN); Qianxi LU, Dongguan (CN); Huei-Ming LIN, South Yarra (AU); Jianhua LIU, Dongguan (CN)

(21) Appl. No.: 17/481,288

(22) Filed: Sep. 21, 2021

Related U.S. Application Data
(63) Continuation of application No. PCT/CN2019/101126, filed on Aug. 16, 2019.

(30) Foreign Application Priority Data
Mar. 28, 2019 (CN) PCT/CN2019/080238

(51) Int. Cl. H04W 24/10; H04W 72/04; H04W 24/08

(52) U.S. Cl. CPC H04W 24/10; H04W 24/08; H04W 72/04

(57) ABSTRACT

A method for radio link management, a terminal device, and a non-transitory computer-readable storage medium are provided. The method is applied to a sidelink communication system including a first terminal device and a second terminal device. The method includes: receiving, by the second terminal device, a sidelink reference signal from the first terminal device; measuring, by the second terminal device, the sidelink reference signal to obtain status information or a measurement result, where the status information or the measurement result is used for indicating a status of a sidelink between the first terminal device and the second terminal device; and reporting, by the second terminal device, the status information or the measurement result to a target device, where the target device includes at least one of the first terminal device, a network device, a group header terminal device of a device group including the second terminal device.

### CROSS-REFERENCE TO RELATED APPLICATION(S)

This application is a continuation of International Application No. PCT/CN2019/101126, filed on Aug. 16, 2019, which claims priority to International Application No. PCT/CN2019/080238, filed on Mar. 28, 2019, the entire disclosures of which are incorporated herein by reference.

### TECHNICAL FIELD

The present disclosure relates to the technical field of communications, and in particular, to a method for radio link management, a terminal device, and a non-transitory computer-readable storage medium.

### BACKGROUND

Device-to-device (D2D) communication or vehicle to everything (V2X) communication is a sidelink (SL) transmission technology. Since long term evaluation (LTE)-V2X communication mainly aims at broadcast services, there is no connection between terminal devices, and the terminal device does not need to perform radio link monitoring (RLM) and radio resource management (RRM). In new radio (NR)-V2X communication, since unicast and multicast services need to be considered, there is connection between the terminal devices, and thus how to perform the RLM and the RRM is a problem that needs to be solved.

### SUMMARY

Implementations of the present disclosure provide a method for radio link management, a terminal device, and a non-transitory computer-readable storage medium.

In a first aspect, implementations of the present disclosure provide a method for radio link management. The method is applied to a sidelink communication system including a first terminal device and a second terminal device. The method includes: receiving, by the second terminal device, a sidelink reference signal from the first terminal device; measuring, by the second terminal device, the sidelink reference signal to obtain status information or a measurement result, where the status information or the measurement result is used for indicating a status of a sidelink between the first terminal device and the second terminal device; and reporting, by the second terminal device, the status information or the measurement result to a target device, where the target device includes at least one of the first terminal device, a network device, a group header terminal device of a device group including the second terminal device.

In a second aspect, implementations of the present disclosure provide a terminal device. The terminal device includes a transceiver, at least one processor, and a memory storing computer programs which, when executed by the at least one processor, cause the transceiver to receive a sidelink reference signal from another terminal device. The computer programs, when executed by the at least one processor, cause the at least one processor to measure the sidelink reference signal to obtain status information or a measurement result, where the status information or the measurement result is used for indicating a status of a sidelink between the terminal device and the another terminal device. The computer programs, when executed by the at least one processor, further cause the transceiver to report the status information or the measurement result to a target device, where the target device includes at least one of the another terminal device, a network device, or a group header terminal device of a device group including the terminal device.

In a third aspect, implementations of the present disclosure provide a non-transitory computer-readable storage medium. The storage medium is configured to store computer programs, when executed by a terminal device, cause the terminal device to receive a sidelink reference signal from another terminal device; measure the sidelink reference signal to obtain status information or a measurement result, where the status information or the measurement result is used for indicating a status of a sidelink between the another terminal device and the terminal device; and report the status information or the measurement result to a target device, where the target device includes at least one of the another terminal device, a network device, or a group header terminal device of a device group including the terminal device.

### BRIEF DESCRIPTION OF THE DRAWINGS

In order to illustrate technical solutions in implementations of the present disclosure more clearly, the following will briefly illustrate accompanying drawings used in description of the implementations. Apparently, the accompanying drawings described below are some implementations of the present disclosure. For those of ordinary skill in the art, other accompanying drawings can be obtained based on these accompanying drawings without creative efforts.

FIG. 1A is a schematic diagram illustrating a network architecture of transmission mode A according to an implementation of the present disclosure.

FIG. 1B is a schematic diagram illustrating a network architecture of transmission mode B according to an implementation of the present disclosure.

FIG. 2A is a schematic flow chart illustrating a method for radio link management according to an implementation of the present disclosure.

FIG. 2B is a schematic diagram illustrating transmission of sidelink data and a sidelink reference signal according to an implementation of the present disclosure.

FIG. 3 is a schematic structural diagram illustrating a terminal device according to an implementation of the present disclosure.

FIG. 4 is a schematic structural diagram illustrating a terminal device according to another implementation of the present disclosure.

### DETAILED DESCRIPTION

The following will illustrate implementations of the present disclosure in detail.

Different from a manner in which communication data is received or transmitted through a base station in a traditional cellular system, an internet of vehicles (IoV) system adopts a device to device (D2D) communication mode, so that a relatively high spectrum efficiency and a relatively low transmission delay can be achieved. The IoV system defines two transmission modes in the 3rd generation partnership project (3GPP): transmission mode A and transmission mode B.

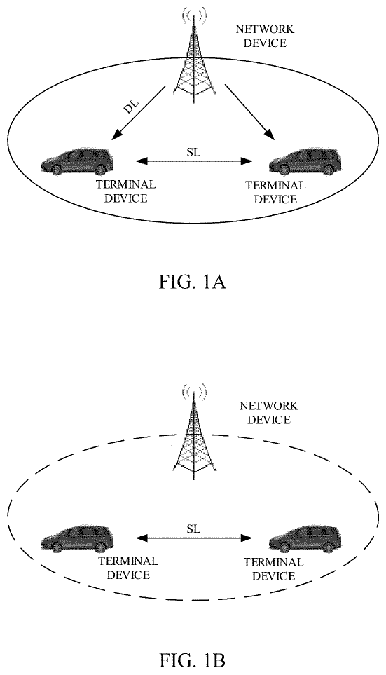

As illustrated in FIG.1A, in transmission mode A, transmission resources for terminal devices (such as vehicle-mounted terminals) are allocated by a network device. The terminal device transmits data on a sidelink (SL) according to resources allocated by the network device. The network device can allocate resources for a single transmission to the terminal device, or allocate resources for semi-persistent transmission to the terminal device.

As illustrated in FIG.1B, in transmission mode B, the terminal device selects a resource from a resource pool to perform data transmission. The terminal device can select the resource from the resource pool randomly or in a listening-selection manner.

The terminal device may be a device that can provide voice and/or data connectivity to a user, for example, a handheld device with a wireless connection function (such as a mobile terminal, a tablet computer, a wearable device, etc.), a vehicle-mounted terminal, or the like.

The network device refers to a node device at a network side. For example, the network device may be a radio access network (RAN) device at an access network side in a cellular network. The so-called RAN device is a kind of device that connects user equipment to a wireless network, including but not limited to: an evolved node B (eNB), a radio network controller (RNC), a node B (NB), a base station controller (BSC), a base transceiver station (BTS), a home base station (for example, a home evolved node B, or a home node B(HNB)), a baseband unit (BBU), or a mobility management entity (MME). For another example, the network device may also be a node device in a wireless local area network (WLAN), such as an access controller (AC), a gateway, or a wireless fidelity (WIFI) access point (AP), and so on.

Since long term evaluation (LTE)-vehicle to everything (V2X) communication mainly aims at broadcast services, there is no connection between terminal devices, and the terminal device does not need to perform radio link management. In new radio (NR)-V2X communication, since unicast and multicast services need to be considered, there is connection between terminal devices. Therefore, in implementations of the present disclosure, a first terminal device transmits a sidelink reference signal to a second terminal device, and then the second terminal device measures the sidelink reference signal to obtain status information or a measurement result, and then reports the status information or the measurement result to a first device (also referred to as a target device). The first device includes at least one of the first terminal device, a network device, or a group header terminal device of a device group including the second terminal device. Therefore, monitoring of a radio link for communication between the first terminal device and the second terminal device is realized, thereby solving a problem that occurs in radio link management for the unicast and multicast services.

What needs to be illustrated is that the radio link management in the implementations of the present disclosure includes radio link monitoring and/or radio resource management.

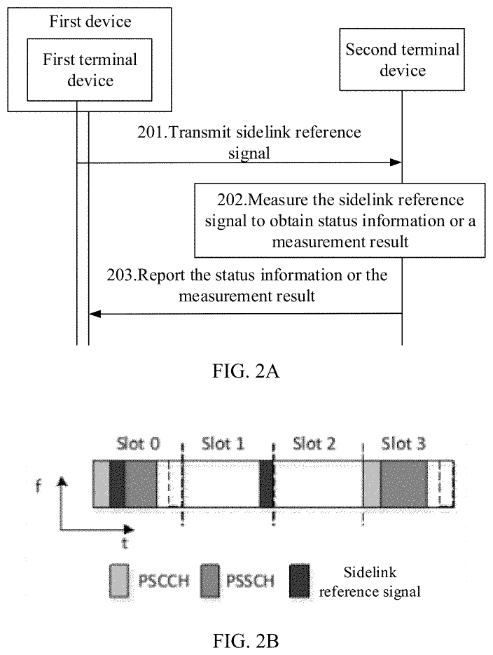

FIG. 2A is a schematic flow chart illustrating a method for radio link management according to an implementation of the present disclosure. The method is applied to a sidelink communication system. The sidelink communication system includes a first terminal device and a second terminal device. The method includes the following.

At block 201, the first terminal device transmits a sidelink reference signal to the second terminal device, and the second terminal device receives the sidelink reference signal from the first terminal device.

At block 202, the second terminal device measures the sidelink reference signal in response to reception of the sidelink reference signal, to obtain status information or a measurement result, where the status information or the measurement result is used for indicating a status of an SL between the first terminal device and the second terminal device.

At block 203, the second terminal device reports the status information or the measurement result to a first device, and the first device receives the status information or the measurement result reported by the second terminal device, where the first device includes at least one of the first terminal device, a network device, or a group header terminal device of a device group including the second terminal device.

Unicast communication refers to a “one-to-one” communication mode between hosts. Multicast communication refers to a “one-to-group” communication mode among hosts.

Before the operation at block 201, a communication connection between the first terminal device and the second terminal device is established in advance.

The sidelink reference signal transmitted by the first terminal device may be configured by the network device, or may be independently selected and transmitted by the first terminal device, which is not uniquely limited herein.

The sidelink reference signal may be any one of a channel state information reference signal (CSI-RS), a phase-tracking reference signal (PT-RS), a demodulation reference signal (DM-RS), or a sounding reference signal (SRS).

The sidelink reference signal can be transmitted together with sidelink data of the terminal device, or can be transmitted separately, which is not uniquely limited herein. For example, as illustrated in FIG. 2B, in time slot 0, the sidelink reference signal and a physical sidelink shared channel (PSSCH) are transmitted together, that is, the first terminal device transmits the PSSCH and the sidelink reference signal in the same time slot, and the sidelink reference signal can occupy a time-domain symbol. In time slot 1, the sidelink reference signal is transmitted separately. There is no PSSCH in time slot 1, and if the first terminal device needs to transmit the sidelink reference signal, the first terminal device needs to transmit the sidelink reference signal separately. When the PSSCH and the sidelink reference signal are transmitted in the same time slot, a frequency-domain resource for the sidelink reference signal and a frequency-domain resource for the PSSCH may be the same or different, which is not limited herein. If the frequency-domain resource for the sidelink reference signal is smaller than the frequency-domain resource for the PSSCH, data of the PSSCH can be mapped on the time-domain symbol occupied by the sidelink reference signal.

Further, the first terminal device transmits the sidelink reference signal in the last time-domain symbol of a time slot. Further, the first terminal device transmits a physical sidelink control channel (PSCCH), where the PSCCH can be used for indicating a transmission resource for the sidelink reference signal, and the transmission resource includes at least one of a time-domain resource, a frequency-domain resource, a space-domain resource, or a code-domain resource.

The status information may include at least one of an in-sync status, an out-of-sync status, or a radio link failure (RLF) status.

The measurement result may include any one of a sidelink reference signal received power (S-RSRP), a sidelink received signal strength indicator (S-RSSI), sidelink path loss information, received power information, or signal to interference plus noise ratio (SINR) information.

In an implementation of the present disclosure, if the first device includes the first terminal device or the group header terminal device of the device group including the second terminal device, the status information or the measurement result is carried in a first sidelink channel. The first sidelink channel may include any one of the PSCCH, the PSSCH, or a physical sidelink feedback channel (PSFCH). The sidelink channel mentioned in the present disclosure is a channel between terminal devices. If the first device includes the network device, the status information or the measurement result is carried in radio resource control (RRC) signaling, downlink control information (DCI), or broadcast information.

In an implementation of the present disclosure, the second terminal device measures the sidelink reference signal to obtain the status information or the measurement result as follows. The second terminal device measures the sidelink reference signal to obtain the measurement result, or the second terminal device measures the sidelink reference signal to obtain the measurement result and performs status determination according to the measurement result to obtain the status information.

In an implementation of the present disclosure, the second terminal device measures the sidelink reference signal to obtain the status information or the measurement result as follows. The second terminal device measures the sidelink reference signal and performs filtering processing, to obtain the status information or the measurement result.

Further, the second terminal device measures the sidelink reference signal and performs filtering processing to obtain the status information or the measurement result as follows. The second terminal device measures the sidelink reference signal to obtain the measurement result and reports the measurement result to a higher layer of the second terminal device, and the higher layer of the second terminal device filters the measurement result to obtain a final measurement result. Alternatively, the second terminal device measures the sidelink reference signal to obtain the measurement result and reports the measurement result to the higher layer of the second terminal device, and the higher layer of the second terminal device filters the measurement result to obtain the final measurement result, and performs status determination according to the final measurement result to obtain the status information.

Filtering the measurement result refers to smoothing the measurement result. For example, as for measuring a sidelink reference signal transmitted on a carrier or a bandwidth part (BWP), a measurement result currently obtained can be smoothed with a measurement result obtained last time or a result obtained by filtering last time (such as taking an average value). For another example, as for measuring a sidelink reference signal transmitted on each of multiple carriers or BWPs, multiple measurement results obtained by measuring the sidelink reference signal transmitted on each of the multiple carriers or the BWPs can be smoothed (such as taking an average value), etc.

In an implementation of the present disclosure, if the first terminal device transmits the sidelink reference signal on at least one carrier or at least one BWP, the terminal device measures the sidelink reference signal to obtain the status information or the measure result as follows. The second terminal device measures the sidelink reference signal transmitted on each carrier of the at least one carrier or on each BWP of the at least one BWP, to obtain the status information or the measurement result. Alternatively, the second terminal device measures the sidelink reference signal transmitted on the at least one carrier, part of carriers in the BWP, or the BWP, respectively, to obtain the status information or the measurement result, where the part of carriers in the BWP are configured by the network device, the first terminal device, or the group header terminal device of the device group including the second terminal device, or independently selected by the second terminal device.

Further, if the SL supports multiple carriers and the multiple carriers include a primary carrier, the at least one carrier is the primary carrier, and if the SL supports the multiple carriers and the multiple carriers do not include the primary carrier, the at least one carrier is the multiple carriers.

If the SL supports the multiple carriers and one of the multiple carriers is the primary carrier, the first terminal device only transmits the sidelink reference signal on the primary carrier, and the second terminal device only measures the sidelink reference signal transmitted on the primary carrier to obtain the measurement result and filters the measurement result.

If the SL supports the multiple carriers and the multiple carriers do not include the primary carrier, the first terminal device uses P carriers to transmit the sidelink data, and thus the first terminal device needs to transmit the sidelink reference signal on each of the P carriers, and the second terminal device needs to measure the sidelink reference signal transmitted on each of the P carriers to obtain a corresponding measurement result and filter each measurement result.

If the SL supports the multiple carriers and the multiple carries do not include the primary carrier, the first terminal device uses the P carriers to transmit the sidelink data, and thus the first terminal device needs to transmit the sidelink reference signal on each of the P carriers, and the second terminal device needs to measure the sidelink reference signal transmitted on each of Q carriers among the P carriers to obtain a corresponding measurement result and filter each measurement result. P or Q is predefined by the protocol, or configured by the network device or the group header terminal device of the device group including the second terminal device, and the Q carriers are configured by the network device, the first terminal device, or the group header terminal device of the device group including the second terminal device, or independently selected by the second terminal device.

What needs to be illustrated is that if the second terminal device measures the sidelink reference signal transmitted on the multiple carries or BWPs, one piece of status information or one measurement result can be obtained, or multiple pieces of status information or multiple measurement results can be obtained (the multiple pieces of status information or the multiple measurement results are in one-to-one correspondence with the multiple carriers or the multiple BWPs).

It can be seen that in the implementation of the present disclosure, the first terminal device transmits the sidelink reference signal to the second terminal device, and then the second terminal device measures the sidelink reference signal to obtain the status information or the measurement result, and reports the status information or the measurement result to the first device. The first device includes at least one of the first terminal device, the network device, or the group header terminal device of the device group including the second terminal device. Therefore, monitoring of a radio link used for communication between the first terminal device and the second terminal device is realized, thereby solving a problem that occurs in radio link management for unicast and multicast services.

In an implementation of the present disclosure, the first terminal device transmits the sidelink reference signal to the second terminal device as follows. The first terminal device transmits the sidelink reference signal to the second terminal device periodically.

Further, the first terminal device transmits the sidelink reference signal to the second terminal device periodically as follows. The first terminal device obtains first configuration information, where the first configuration information includes first indication information and/or second indication information, the first indication information is used for determining a transmission resource for the sidelink reference signal, and the second indication information is used for determining a transmission period of the sidelink reference signal. The first terminal device transmits the sidelink reference signal to the second terminal device periodically according to the first configuration information.

In case that the first configuration information does not include the first indication information, the first terminal device independently selects the transmission resource for the sidelink reference signal. In case that the first configuration information does not include the second indication information, the first terminal device independently selects the transmission period of the sidelink reference signal.

The transmission resource includes at least one of the time-domain resource, the frequency-domain resource, the space-domain resource, and the code-domain resource.

In an implementation, a set of sidelink-reference-signal configuration information is configured in advance. Each piece of sidelink-reference-signal configuration information can be used for determining the transmission resource for the sidelink reference signal. The first indication information includes one piece of index information, where the piece of index information corresponds to one piece of sidelink-reference-signal configuration information in the set of sidelink-reference-signal configuration information, and thus the transmission resource for the sidelink reference signal can be determined according to the index information.

In an implementation, the first indication information includes transmission-resource indication information, and the transmission resource for the sidelink reference signal can be determined according to the first indication information. For example, the first indication information includes time-domain-resource indication information and/or frequency-domain-resource indication information, and the time-domain resource and/or the frequency-domain resource for transmitting the sidelink reference signal can be determined according to the time-domain-resource indication information and/or the frequency-domain-resource indication information.

Further, the first configuration information is predefined by the protocol, or configured by the network device, a group header terminal device of a device group including the first terminal device, or the second terminal device.

Further, if the first configuration information is configured by the group header terminal device of the device group including the first terminal device or the second terminal device, the first configuration information is carried in a second sidelink channel, where the second sidelink channel includes any of the PSCCH, the PSSCH, or the PSBCH. If the first configuration information is configured by the network device, the first configuration information is carried in the RRC signaling, the DCI, or the broadcast information.

If terminal device 1 and terminal device 2 are group members in a multicast communication group and terminal device 3 is a group header terminal device, terminal device 3 can configure the first configuration information for communication between members in the group. The group header terminal device in the multicast communication group is a terminal device with functions such as management, control, coordination, and scheduling.

For example, assuming that the first configuration information includes the first indication information and the second indication information, the first terminal device determines the transmission resource for the sidelink reference signal as transmission resource 1 according to the first indication information, and determines, according to the second indication information, that the transmission period of the sidelink reference signal is performing transmission once every minute, then the first terminal device transmits the sidelink reference signal once every minute on transmission resource 1.

It can be seen that in the implementation of the present disclosure, the first terminal device periodically transmits the sidelink reference signal to the second terminal device, so that the second terminal device periodically measures a link status of the SL between the first terminal device and the second terminal device.

In an implementation of the present disclosure, the first terminal device transmits the sidelink reference signal to the second terminal device as follows. The first terminal device obtains a first parameter, where the first parameter is used for indicating a maximum time interval between each two adjacent transmissions of the sidelink reference signal. The first terminal device transmits the sidelink reference signal to the second terminal device according to the first parameter.

Further, the first parameter is predefined by the protocol, configured by the network device or the group header terminal device of the device group including the first terminal device, independently selected by the first terminal device, or configured by the second terminal device.

Further, if the first parameter is configured by the group header terminal device of the device group including the first terminal device or configured by the second terminal device, the first parameter is carried in a third sidelink channel, where the third sidelink channel includes any of the PSCCH, the PSSCH, or the PSBCH. If the first parameter is configured by the network device, the first parameter is carried in the RRC signaling, the DCI, or the broadcast information.

For example, assuming that the first parameter is T, the first terminal device transmits the sidelink reference signal at time n1, then the first terminal device transmits the sidelink reference signal once more within time [n1+T1, n1+T2], where T1 is an integer larger than or equal to 1, T2<=T, and T1 and T2 can be independently selected by the first terminal device or configured by the network device.

It can be seen that in the implementation of the present disclosure, the first terminal device transmits the sidelink reference signal to the second terminal device aperiodically, so as to measure the link status of the SL between the first terminal device and the second terminal device according to actual situation.

In an implementation of the present disclosure, the first terminal device transmits the sidelink reference signal to the second terminal device as follows. The first terminal device obtains third indication information, where the third indication information is used for instructing the first terminal device to transmit the sidelink reference signal. The first terminal device transmits the sidelink reference signal to the second terminal device according to the third indication information.

Further, the third indication information is transmitted by the network device, the group header terminal device of the device group including the first terminal device, or the second terminal device.

For example, when the first terminal device works in a mode in which the network device allocates a transmission resource for the SL (such as mode 3 in LTE-V2X communication, or mode 1 in NR-V2X communication), the transmission resource for the SL of the first terminal device is scheduled by the network device. The network device can transmit the third indication information to instruct the first terminal device to transmit the sidelink reference signal for radio link measurement, and the first terminal device transmits the sidelink reference signal according to the third indication information.

For another example, in the multicast communication, a group header terminal device can control sidelink transmission between group members. Therefore, the group header terminal device can transmit the third indication information to instruct the first terminal device to transmit the sidelink reference signal for radio link measurement. The first terminal device transmits the sidelink reference signal according to the third indication information.

For another example, in the unicast communication, in order to perform the radio link measurement, the second terminal device can transmit the third indication information to the first terminal device to trigger the first terminal device to transmit the sidelink reference signal, so that the second terminal device can perform the radio link measurement according to the sidelink reference signal.

Further, the third indication information is further used for indicating at least one of the transmission resource for the sidelink reference signal, the transmission period of the sidelink reference signal, or a delay requirement of the sidelink reference signal.

The delay requirement of the sidelink reference signal refers to a maximum delay of transmitting of the sidelink reference signal. For example, assuming that the delay requirement is t, and the first terminal device transmits the third indication information at time n2, then the first terminal device transmits the sidelink reference signal within time [n2+t1, n2+t2], where t1 is an integer larger than or equal to 1, t2<=t, and t1 and t2 can be independently selected by the first terminal device, or configured by the network device or the second terminal device.

If the third indication information is not used for indicating the transmission resource for the sidelink reference signal, the first terminal device independently selects the transmission resource for the sidelink reference signal. If the third indication information is not used for indicating the transmission period of the sidelink reference signal, the first terminal device independently selects the transmission period of the sidelink reference signal. If the third indication information is not used for indicating the delay requirement of the sidelink reference signal, the first terminal device independently selects the delay requirement of the sidelink reference signal.

What needs to be illustrated is that the third indication information is used for instructing the first terminal device to transmit the sidelink reference signal, and the third indication information is used for indicating the transmission resource for the sidelink reference signal, the transmission period of the sidelink reference signal, and the delay requirement of the sidelink reference signal. The transmission resource for the sidelink reference signal, the transmission period of the sidelink reference signal, and the delay requirement of the sidelink reference signal may be indicated by the same indication information or different indication information, which is not limited herein.

Further, if the third indication information is transmitted by the group header terminal device of the device group including the second terminal device or transmitted by the second terminal device, the third indication information is carried in a fourth sidelink channel, and the fourth sidelink channel includes one of the PSCCH, the PSSCH, or the PSBCH. If the third indication information is configured by the network device, the third indication information is carried in the RRC signaling, the DCI, or the broadcast information.

It can be seen that in the implementation of the present disclosure, the first terminal device transmits the sidelink reference signal to the second terminal device according to the third indication information, so as to measure the link status of the SL between the first terminal device and the second terminal device according to actual situation.

In an implementation of the present disclosure, the method further includes the following. The first terminal device transmits the sidelink data to the second terminal device. The second terminal device receives the sidelink data transmitted by the first terminal device. If the measurement result obtained by measuring the sidelink reference signal is higher than a first threshold, the second terminal device transmits feedback information to the first terminal device, where the feedback information is used for indicating whether the sidelink data is correctly received by the second terminal device. The first terminal device receives the feedback information transmitted by the second terminal device.

Further, the method further includes the following. If the measurement result obtained by measuring the sidelink reference signal is lower than the first threshold, the second terminal device refuses to transmit the feedback information to the first terminal device.

Further, the first threshold is predefined by the protocol, or configured by the network device, the group header terminal device of the device group including the second terminal device, or the first terminal device.

Further, if the first threshold is configured by the group header terminal device of the device group including the second terminal device or configured by the first terminal device, the first threshold is carried in a fifth sidelink channel, and the fifth sidelink channel includes one of the PSCCH, the PSSCH, or the PSBCH. If the first threshold is configured by the network device, the first threshold is carried in the RRC signaling, the DCI, or the broadcast information.

Further, the first threshold is determined according to service attribute of the sidelink data transmitted between the first terminal device and the second terminal device, where the service attribute includes at least one of a priority, reliability, a time delay, a communication range, a service type, or a logical channel.

The communication range refers to a transmission distance requirement of the sidelink data transmitted. The service type refers to a service type of the sidelink data transmitted. The logical channel refers to a logical channel that carries the sidelink data transmitted. The priority refers to a transmission priority of the logical channel carrying the sidelink data transmitted. The reliability refers to a reliability requirement of the sidelink data transmitted. The time delay refers to a delay requirement of the sidelink data transmitted.

The feedback information includes any one of hybrid automatic repeat request (HARQ) acknowledgement (ACK), HARQ negative acknowledgement (NACK), or discontinuous transmission (DTX).

It can be seen that in the implementation of the present disclosure, the status of the SL between the first terminal device and the second terminal device is fed back again via the feedback information, and thus the radio link can be further monitored.

In an implementation of the present disclosure, the second terminal device reports the status information or the measurement result to the first device as follows. The second terminal device periodically reports the status information or the measurement result to the first device.

Further, a reporting period of reporting the status information or the measurement result is predefined by the protocol, or configured by the network device, the group header terminal device of the device group including the second terminal device, or the first terminal device.

If the reporting period is configured by the group header terminal device of the device group including the second terminal device or configured by the first terminal device, the reporting period is carried in a sixth sidelink channel, and the sixth sidelink channel includes one of the PSCCH, the PSSCH, or the PSBCH. If the reporting period is configured by the network device, the reporting period is carried in the RRC signaling, the DCI, or the broadcast information.

It can be seen that in the implementation of the present disclosure, the second terminal device periodically reports the measurement result or the status information to the first terminal device, so that the first terminal device periodically learns the link status of the SL between the first terminal device and the second terminal device.

In an implementation of the present disclosure, the second terminal device reports the status information or the measurement result to the first device as follows. In response to a first triggering condition, the second terminal device reports the status information or the measurement result to the first device. The first triggering condition includes at least one of the following. The measurement result obtained by measuring the sidelink reference signal by the second terminal device is a first status, and a duration of the first status exceeds a second threshold. N measurement results consecutively obtained by the second terminal device are all the first status. The measurement result obtained by measuring the sidelink reference signal by the second terminal device is the first status, and status information reported by the second terminal device last time is second status. A timer associated with reporting of the status information or the measurement result expires. A counter associated with the reporting of the status information or the measurement result reaches a third threshold.

The first status is different from the second status. The first status may be an out-of-sync status or an in-sync status. The second status may be the out-of-sync status or the in-sync status.

For example, if the measurement result obtained by measuring the sidelink reference signal by the second terminal device is lower than the first threshold, the measurement result is considered to be the out-of-sync status. If a duration of the out-of-sync status exceeds the second threshold, the second terminal device is triggered to report the status information or the measurement result to the first terminal device.

For another example, if the measurement result obtained by measuring the sidelink reference signal by the second terminal device is higher than the first threshold, the measurement result is considered to be the in-sync status. If a duration of the in-sync status exceeds the second threshold, the second terminal device is triggered to report the status information or the measurement result to the first terminal device.

For another example, if the N measurement results consecutively obtained by the second terminal device are all the out-of-sync status or the in-sync status, the second terminal device is triggered to report the status information or the measurement result to the first terminal device.

For another example, if the measurement result obtained by measuring the sidelink reference signal by the second terminal device this time is the in-sync status, and a measurement result obtained by measuring the sidelink reference signal by the second terminal device last time is the out-of-sync status, the second terminal device is triggered to report the status information or the measurement result to the first terminal device.

For another example, the timer is activated in response to reporting the status information or the measurement result by the second terminal device last time. When the timer expires, the second terminal device is triggered to report the status information or the measurement result to the first terminal device.

For another example, the counter is activated in response to reporting the status information or the measurement result by the second terminal device last time. An initial value of the counter is K (for example, K=20). The second terminal device updates the counter in each time slot, for example, the counter decreases by 1. When the counter decreases to 0, the second terminal device is triggered to transmit the status information or the measurement result to the first terminal device.

Further, the second threshold, the third threshold, or the N is configured for each carrier, or the second threshold, the third threshold or the N is configured for the primary carrier.

Further, for a multi-carrier scenario, if the primary carrier exists, when a measurement result for the primary carrier meets a triggering condition, the reporting of the status information or the measurement result is triggered. For another example, when a measurement result for any carrier meets the triggering condition, the reporting of the status information or the measurement result is triggered. For yet another example, measurement results for all carriers are counted together, and if the triggering condition is met, the reporting of the status information or the measurement result is triggered.

Further, the second threshold, the third threshold, or the N is predefined by the protocol, or configured by the network device, the group header terminal device of the device group including the second terminal device, or the first terminal device.

If the second threshold, the third threshold or the N is configured by the group header terminal device including the second terminal device or configured by the first terminal, then the second threshold, the third threshold or the N is carried in a seventh sidelink channel, where the seventh sidelink channel includes one of the PSCCH, the PSSCH, or the PSBCH. If the second threshold, the third threshold or the N is configured by the network device, the second threshold, the third threshold or the N is carried in the RRC signaling, the DCI, or the broadcast information.

It can be seen that, in the implementation of the present disclosure, the second terminal device reports the status information or the measurement result to the first terminal device in response to a certain triggering condition, so as to realize the reporting of the link status of the SL between the first terminal device and the second terminal device according to actual situation.

In an implementation of the present disclosure, the second terminal device reports the status information or the measurement result to the first device as follows. The second terminal device reports the status information or the measurement result to the first device in response to a first variation value exceeding a fourth threshold, where the first variation value is used for indicating a variation of first information obtained by measuring the sidelink reference signal by the second terminal device.

The first information includes, for example, the S-RSRP, the S-RSSI, the sidelink path loss information, the received power information, the SINR, or other information.

The first information determined by measuring the sidelink reference signal this time is the same as the measurement result reported by the second terminal device (for example, the first information is the S-RSRP, and the measurement result reported is also the S-RSRP). For another example, the first information determined by measuring the sidelink reference signal this time is different from the measurement result reported by the second terminal device (for example, the first information is the sidelink loss information, and the measurement result reported is the S-RSRP), which is not limited herein.

The first information and the measurement result can be simultaneously obtained by measuring the sidelink reference signal, or can be respectively obtained by measuring the sidelink reference signal, which is not limited herein.

The first variation value is determined based on a comparison result.

The comparison result is obtained by comparing the first information determined by measuring the sidelink reference signal by the second terminal device at current time with first information determined by measuring the sidelink reference signal by the second terminal device last time.

For example, assuming that the first information is the S-RSRP, the S-RSRP determined by measuring the sidelink reference signal by the second terminal device at current time is 15 dB, and the S-RSRP determined by measuring the sidelink reference signal by the second terminal device last time is 7 dB, then the first variation value is 8 dB obtained by subtracting 15 dB from 17 dB. If the fourth threshold is 6 dB, the second terminal device determines that the condition of reporting the status information or the measurement result is met.

The comparison result is obtained by comparing the first information determined by measuring the sidelink reference signal by the second terminal device at current time with first information corresponding to reporting the status information or the measurement result by the second terminal device last time.

For example, if the first information is the sidelink loss information, the measurement report reported by the second terminal device is the S-RSRP, the sidelink loss information obtained by measuring the sidelink reference signal by the second terminal device at current time is A, and the sidelink loss information corresponding to reporting the S-RSRP by the second terminal device last time is B, then the first variation value is A-B. If A-B>the fourth threshold, the second terminal device determines that the condition of reporting the status information or the measurement result is met.

The fourth threshold is predefined by the protocol, or configured by the network device, the group header terminal device of the device group including the second terminal device, or the first terminal device.

It can be seen that in the implementation of the present disclosure, the second terminal device reports the status information or the measurement result to the first terminal device in response to a certain condition, so as to realize the reporting of the link status of the SL between the first terminal device and the second terminal device according to actual situation.

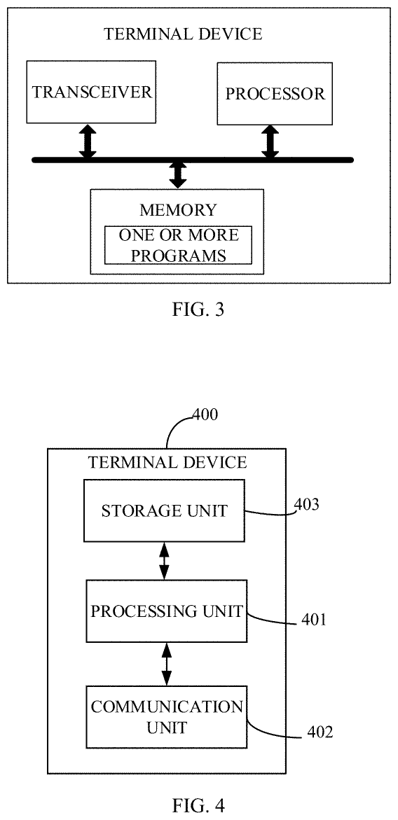

FIG. 3 is a schematic structural diagram illustrating a terminal device according to implementations of the present disclosure. The terminal device is applied to a sidelink communication system including a first terminal device and a second terminal device. As illustrated in FIG. 3, the terminal device includes one or more processors, one or more memories, one or more transceivers, and one or more programs. The one or more programs are stored in the one or more memories and configured to be executed by the one or more processors.

In an implementation of the present disclosure, the terminal device illustrated in FIG. 3 is the first terminal device, and the one or more programs include instructions used for performing the following operations: transmitting a sidelink reference signal to the second terminal device; receiving status information or a measurement result reported by the second terminal device, where the status information or the measurement result is obtained by the second terminal device by measuring the sidelink reference signal, and the status information or the measurement result is used for indicating a status of an SL between the first terminal device and the second terminal device.

Further, regarding transmitting the sidelink reference signal to the second terminal device, the one or more programs include instructions used for performing the following operation: transmitting the sidelink reference signal to the second terminal device periodically.

Further, regarding transmitting the sidelink reference signal to the second terminal device periodically, the one or more programs include instructions used for performing the following operations: obtaining first configuration information, where the first configuration information includes first indication information and/or second indication information, the first indication information is used for determining a transmission resource for the sidelink reference signal, and the second indication information is used for determining a transmission period of the sidelink reference signal; and transmitting the sidelink reference signal to the second terminal device periodically according to the first configuration information.

Further, the first configuration information is predefined by a protocol, or configured by a network device, a group header terminal device of a device group including the first terminal device, or the second terminal device.

Further, regarding transmitting the sidelink reference signal to the second terminal device, the one or more programs include instructions used for performing the following operations: obtaining a first parameter, where the first parameter is used for indicating a maximum time interval between each two adjacent transmissions of the sidelink reference signal; and transmitting the sidelink reference signal to the second terminal device according to the first parameter.

Further, the first parameter is predefined by the protocol, configured by the network device or the group header terminal device of the device group including the first terminal device, independently selected by the first terminal device, or configured by the second terminal device.

Further, regarding transmitting the sidelink reference signal to the second terminal device, the one or more programs include instructions used for performing the following operations: obtaining third indication information, where the third indication information is used for instructing the first terminal device to transmit the sidelink reference signal; and transmitting the sidelink reference signal to the second terminal device according to the third indication information.

Further, the third indication information is transmitted by the network device, the group header terminal device of the device group including the first terminal device, or the second terminal device.

Further, the third indication information is further used for indicating at least one of: a transmission resource for the sidelink reference signal, a transmission period of the sidelink reference signal, or a delay requirement of the sidelink reference signal.

Further, the status information or the measurement result is obtained by the second terminal device by measuring the sidelink reference signal as follows. The status information or the measurement result is obtained by the second terminal device by measuring the sidelink reference signal and performing filtering processing.

Further, the one or more programs further include instructions used for performing the following operations: transmitting sidelink data to the second terminal device; receiving feedback information transmitted by the second terminal device, where the feedback information is used for indicating whether the sidelink data is correctly received by the second terminal device, and the feedback information is transmitted in response to the measurement result obtained by the second terminal device by measuring the sidelink reference signal being higher than a first threshold.

Further, the first threshold is predefined by the protocol, or configured by the network device, a group header terminal device of a device group including the second terminal device, or the first terminal device.

Further, the first threshold is determined according to service attribute of the sidelink data transmitted between the first terminal device and the second terminal device, where the service attribute includes at least one of a priority, reliability, a time delay, a communication range, a service type, or a logical channel.

In another implementation of the present disclosure, the terminal device illustrated in FIG. 3 is the second terminal device. The one or more programs include instructions used for performing the following operations: receiving a sidelink reference signal from the first terminal device; measuring the sidelink reference signal to obtain status information or a measurement result, where the status information or the measurement result is used for indicating status of an SL between the first terminal device and the second terminal device; and reporting the status information or the measurement result to a first device, where the first device includes at least one of the first terminal device, a network device, or a group header terminal device of a device group including the second terminal device.

Further, in case that the first terminal device transmits the sidelink reference signal on at least one carrier or at least one BWP, regarding measuring the sidelink reference signal to obtain the status information or the measurement result, the one or more programs include instructions use for performing the following operations: measuring the sidelink reference signal transmitted on each carrier of the at least one carrier or on each BWP of the at least one BWP, to obtain the status information or the measurement result.

Further, regarding measuring the sidelink reference signal to obtain the status information or the measurement result, the one or more programs include instructions use for performing the following operations: measuring the sidelink reference signal and performing filtering processing, to obtain the status information or the measurement result.

Further, if the SL supports multiple carriers and the multiple carriers include a primary carrier, the at least one carrier is the primary carrier, and if the sidelink supports the multiple carriers and the multiple carriers does not include the primary carrier, the at least one carrier is the multiple carriers.

Further, the one or more programs further include instructions used for performing the following operations: receiving sidelink data transmitted by the first terminal device; and transmitting feedback information to the first terminal device in response to the measurement result obtained by measuring the sidelink reference signal being higher than a first threshold, where the feedback information is used for indicating whether the sidelink data is correctly received by the second terminal device.

Further, the one or more programs further include instructions used for performing the following operation: refusing to transmit the feedback information to the first terminal device in response to the measurement result obtained by measuring the sidelink reference signal being lower than the first threshold.

Further, the first threshold is predefined by a protocol, or configured by the network device, the group header terminal device of the device group including the second terminal device, or the first terminal device.

Further, the first threshold is determined according to service attribute of the sidelink data transmitted between the first terminal device and the second terminal device, where the service attribute includes at least one of a priority, reliability, a time delay, a communication range, a service type, or a logical channel.

Further, regarding reporting the status information or the measurement report to the first device, the one or more programs include instructions used for performing the following operation: reporting the status information or the measurement report to the first device periodically.

Further, a period of reporting the status information or the measurement result is predefined by the protocol, or configured by the network device, the group header terminal device of the device group including the second terminal device, or the first terminal device.

Further, regarding reporting the status information or the measurement report to the first device, the one or more programs include instructions used for performing the following operation: reporting the status information or the measurement result to the first device in response to a first triggering condition, where the first triggering condition includes at least one of: the measurement result obtained by the second terminal device by measuring the sidelink reference signal being a first status, and a duration of the first status exceeding a second threshold; N measurement results consecutively obtained by the second terminal device being all the first status; the measurement result obtained by the second terminal device by measuring the sidelink reference signal being the first status, and status information reported by the second terminal device last time being a second status; a timer associated with reporting of the status information or the measurement result expiring; or a counter associated with the reporting of the status information or the measurement result reaching a third threshold.

Further, the second threshold, the third threshold or the N is configured for each carrier or the primary carrier.

Further, the second threshold, the third threshold or the N is predefined by the protocol, or configured by the network device, the group header terminal device of the device group including the second terminal device, or the first terminal device.

In an implementation of the present disclosure, regarding reporting the status information or the measurement result to the first device, the one or more programs include instructions used for performing the following operation: reporting, by the second terminal device, the status information or the measurement result to the first device in response to a first variation value exceeding a fourth threshold, where the first variation value is used for indicating a variation of first information determined by the second terminal device by measuring the sidelink reference signal.

In an implementation of the present disclosure, the fourth threshold is predefined by the protocol, or configured by the network device, the group header terminal device of the device group including the second terminal device, or the first terminal device.

What needs to be illustrated is that, for detailed implementation manners of the implementations in the present disclosure, reference can be made to the above methods, which will not be repeated herein.

FIG. 4 is a schematic structural diagram illustrating a terminal device 400 in implementations of the present disclosure. The terminal device 400 is applied to a sidelink communication system including a first terminal device and a second terminal device. The terminal device 400 includes a processing unit 401, a communication unit 402, and a storage unit 403.

In an implementation of the present disclosure, the terminal device illustrated in FIG. 4 is the first terminal device, and the processing unit 401 is configured to transmit, through the communication unit 402, a sidelink reference signal to the second terminal device; and receive, through the communication unit 402, status information or a measurement result reported by the second terminal device, where the status information or the measurement result is obtained by the second terminal device by measuring the sidelink reference signal, and the status information or the measurement result is used for indicating a status of an SL between the first terminal device and the second terminal device.

Further, regarding transmitting the sidelink reference signal to the second terminal device, the processing unit 401 is configured to transmit, through the communication unit 402, the sidelink reference signal to the second terminal device periodically.

Further, regarding transmitting the sidelink reference signal to the second terminal device periodically, the processing unit 401 is configured to obtain first configuration information, where the first configuration information includes first indication information and/or second indication information, the first indication information is used for determining a transmission resource for the sidelink reference signal, and the second indication information is used for determining a transmission period of the sidelink reference signal; transmit, through the communication unit 402, the sidelink reference signal to the second terminal device periodically according to the first configuration information.

Further, the first configuration information is predefined by a protocol, or configured by a network device, a group header terminal device of a device group including the first terminal device, or the second terminal device.

Further, regarding transmitting the sidelink reference signal to the second terminal device, the processing unit 401 is configured to obtain a first parameter, where the first parameter is used for indicating a maximum time interval between each two adjacent transmissions of the sidelink reference signal; and transmit, through the communication unit 402, the sidelink reference signal to the second terminal device according to the first parameter.

Further, the first parameter is predefined by the protocol, configured by the network device or the group header terminal device of the device group including the first terminal device, independently selected by the first terminal device, or configured by the second terminal device.

Further, regarding transmitting the sidelink reference signal to the second terminal device, the processing unit 401 is configured to obtain third indication information, where the third indication information is used for instructing the first terminal device to transmit the sidelink reference signal; and transmit, through the communication unit 402, the sidelink reference signal to the second terminal device according to the third indication information.

Further, the third indication information is transmitted by the network device, the group header terminal device of the device group including the first terminal device, or the second terminal device.

Further, the third indication information is further used for indicating at least one of: a transmission resource for the sidelink reference signal, a transmission period of the sidelink reference signal, or a delay requirement of the sidelink reference signal.

Further, the status information or the measurement result is obtained by the second terminal device by measuring the sidelink reference signal as follows. The status information or the measurement result is obtained by the second terminal device by measuring the sidelink reference signal and performing filtering processing.

Further, the processing unit 401 is further configured to transmit, through the communication unit 402, sidelink data to the second terminal device; receive, through the communication unit 402, feedback information transmitted by the second terminal device, where the feedback information is used for indicating whether the sidelink data is correctly received by the second terminal device, and the feedback information is transmitted in response to the measurement result obtained by the second terminal device by measuring the sidelink reference signal being higher than a first threshold.

Further, the first threshold is predefined by the protocol, configured by the network device, a group header terminal device of a device group including the second terminal device, or the first terminal device.

Further, the first threshold is determined according to service attribute of the sidelink data transmitted between the first terminal device and the second terminal device, where the service attribute includes at least one of: a priority, reliability, a time delay, a communication range, a service type, or a logical channel.

In another implementation of the present disclosure, the terminal device illustrated in FIG. 4 is the second terminal device, and the processing unit 401 is configured to receive, through the communication unit 402, a sidelink reference signal from the first terminal device; measure the sidelink reference signal to obtain status information or a measurement result, where the status information or the measurement result is used for indicating a status of an SL between the first terminal device and the second terminal device; and report, through the communication unit 402, the status information or the measurement result to a first device, where the first device includes at least one of the first terminal device, a network device, or a group header terminal device of a device group including the second terminal device.

Further, in case that the first terminal device transmits the sidelink reference signal on at least one carrier or at least one BWP, regarding measuring the sidelink reference signal to obtain the status information or the measurement result, the processing unit 401 is configured to measure the sidelink reference signal transmitted on each carrier of the at least one carrier or on each BWP of the at least one BWP, to obtain the status information or the measurement result.

Further, regarding measuring the sidelink reference signal to obtain the status information or the measurement result, the processing unit 401 is configured to measure the sidelink reference signal and perform filtering processing, to obtain the status information or the measurement result.

Further, if the sidelink supports multiple carriers and the multiple carriers include a primary carrier, the at least one carrier is the primary carrier, and if the sidelink supports the multiple carriers and the multiple carriers does not include the primary carrier, the at least one carrier is the multiple carriers.

Further, the processing unit 401 is further configured to receive, through the communication unit 402, sidelink data transmitted by the first terminal device; and transmit, through the communication unit 402, feedback information to the first terminal device in response to the measurement result obtained by measuring the sidelink reference signal being higher than a first threshold, where the feedback information is used for indicating whether the sidelink data is correctly received by the second terminal device.

Further, the processing unit 401 is further configured to refuse to transmit the feedback information to the first terminal device in response to the measurement result obtained by measuring the sidelink reference signal being lower than the first threshold.

Further, the first threshold is predefined by a protocol, or configured by the network device, the group header terminal device of the device group including the second terminal device, or the first terminal device.

Further, the first threshold is determined according to service attribute of the sidelink data transmitted between the first terminal device and the second terminal device, where the service attribute includes at least one of: a priority, reliability, a time delay, a communication range, a service type, or a logical channel.

Further, regarding reporting the status information or the measurement report to the first device, the processing unit 401 is configured to report, through the communication unit 402, the status information or the measurement report to the first device periodically.

Further, a period of reporting the status information or the measurement result is predefined by the protocol, or configured by the network device, the group header terminal device of the device group including the second terminal device, or the first terminal device.

Further, regarding reporting the status information or the measurement report to the first device, the processing unit 401 is configured to report the status information or the measurement result to the first device in response to a first triggering condition, where the first triggering condition includes at least one of: the measurement result obtained by the second terminal device by measuring the sidelink reference signal being a first status, and a duration of the first status exceeding a second threshold; N measurement results consecutively obtained by the second terminal device being all the first status; the measurement result obtained by the second terminal device by measuring the sidelink reference signal being the first status, and status information reported by the second terminal device last time being a second status; a timer associated with reporting of the status information or the measurement result expiring; or a counter associated with the reporting of the status information or the measurement result reaching a third threshold.

Further, the second threshold, the third threshold or the N is configured for each carrier or the primary carrier.

Further, the second threshold, the third threshold or the N is predefined by the protocol, or configured by the network device, the group header terminal device of the device group including the second terminal device, or the first terminal device.

In an implementation of the present disclosure, regarding reporting the status information or the measurement report to the first device, the processing unit 401 is configured to report, through the communication unit 402, the status information or the measurement result to the first device in response to a first variation value exceeding a fourth threshold, where the first variation value is used for indicating a variation of first information determined by the second terminal device by measuring the sidelink reference signal.

In an implementation of the present disclosure, the fourth threshold is predefined by the protocol, or configured by the network device, the group header terminal device of the device group including the second terminal device, or the first terminal device.

If the processing unit 401 is a processor, the communication unit 402 is a transceiver, and the storage unit 403 is a memory, the terminal device involved in the implementations of the present disclosure may be the terminal device illustrated in FIG. 3.

Implementations of the present disclosure further provide a computer-readable storage medium. The computer-readable storage medium stores a computer program used for electronic data interchange. The computer program enables a computer to perform part of or all the operations executed by the first terminal device or the second terminal device in the above-mentioned method implementations.

Implementations of the present disclosure further provide a computer program product. The computer program product includes a non-transitory computer-readable storage medium storing a computer program. The computer program can be executed to enable a computer to perform part of or all the operations executed by the first terminal device or the second terminal device in the above-mentioned method implementations. The computer program product may be a software installation package.

The operations of the methods or algorithms described in the implementations of the present disclosure may be implemented in a hardware manner, or may be implemented in a manner in which a processor executes software instructions. The software instructions can be composed of corresponding software modules, and the software modules can be stored in a random access memory (RAM), a flash memory, a read only memory (ROM), and an erasable programmable ROM (EPROM), an electrically erasable programmable ROM (EEPROM), a register, a hard disk, a portable hard disk, a CD-ROM, or any other form of storage medium known in the art. An exemplary storage medium is coupled to a processor, so that the processor can read information from the storage medium and write information to the storage medium. Of course, the storage medium may also be an integral part of the processor. The processor and the storage medium may be located in an application specific integrated circuit (ASIC). In addition, the ASIC may be located in an access network device, a target network device, or a core network device. Of course, the processor and the storage medium may also exist as discrete components in the access network device, the target network device, or the core network device.

Those skilled in the art should be aware that, in one or more of the foregoing examples, the functions described in the implementations of the present disclosure may be implemented in whole or in part by software, hardware, firmware, or any combination thereof. When implemented by software, it can be implemented in the form of a computer program product in whole or in part. The computer program product includes one or more computer instructions. When the computer instructions are loaded and executed by a computer, all or part of the processes or functions described in the implementations of the present disclosure are generated. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a website, a computer, a server, or a data center to another website, another computer, another server, or another data center in a wired manner (such as a coaxial cable, an optical fiber, a digital subscriber line (DSL)) or a wireless manner (such as infrared, wireless, microwave, etc.). The computer-readable storage medium may be any available medium that can be accessed by the computer or a data storage device such as a server or data center integrated with one or more available mediums. The available medium may be a magnetic medium (for example, a floppy disk, a hard disk, or a magnetic tape), an optical medium (for example, a digital video disc (DVD)), or a semiconductor medium (for example, a solid state disk (SSD)), and so on.

The implementation manners described above further describe the purpose, the technical solutions, and the advantages of the implementations of the present disclosure. It should be understood that the foregoing descriptions are only implementation manners of the implementations of the present disclosure, rather than used to limit the protection scope of the implementations of the present disclosure. Any modification, equivalent replacement, improvement, etc., made on the basis of the technical solutions of the implementations of the present disclosure shall fall in the protection scope of the implementations of the present disclosure.

What is claimed is:

1. A method for radio link management, being applied to a sidelink communication system comprising a first terminal device and a second terminal device, the method comprising:
receiving, by the second terminal device, a sidelink reference signal from the first terminal device;
measuring, by the second terminal device, the sidelink reference signal to obtain status information or a measurement result, wherein the status information or the measurement result is used for indicating a status of a sidelink between the first terminal device and the second terminal device; and
reporting, by the second terminal device, the status information or the measurement result to a target device, wherein the target device comprises at least one of the first terminal device, a network device, or a group header terminal device of a device group comprising the second terminal device.

2. The method of claim 1, wherein in case that the first terminal device transmits the sidelink reference signal on at least one carrier or at least one bandwidth part (BWP), measuring, by the second terminal device, the sidelink reference signal to obtain the status information or the measurement result, comprises:
measuring, by the second terminal device, the sidelink reference signal transmitted on each carrier of the at least one carrier or on each BWP of the at least one BWP, to obtain the status information or the measurement result.

3. The method of claim 1, wherein measuring, by the second terminal device, the sidelink reference signal to obtain the status information or the measurement result, comprises:
measuring, by the second terminal device, the sidelink reference signal and performing, by the second terminal device, filtering processing, to obtain the status information or the measurement result.

4. The method of claim 1, further comprising:
receiving, by the second terminal device, sidelink data transmitted by the first terminal device;
transmitting, by the second terminal device, feedback information to the first terminal device in response to the measurement result obtained by measuring the sidelink reference signal being higher than a threshold, wherein the feedback information is used for indicating whether the sidelink data is correctly received by the second terminal device; and
refusing, by the second terminal device, to transmit the feedback information to the first terminal device in response to the measurement result obtained by measuring the sidelink reference signal being lower than the threshold.

5. The method of claim 4, wherein the threshold is determined according to service attribute of the sidelink data transmitted between the first terminal device and the second terminal device, wherein the service attribute comprises at least one of: a priority, reliability, a time delay, a communication range, a service type, or a logical channel.

6. The method of claim 1, wherein reporting, by the second terminal device, the status information or the measurement result to the target device, comprises:
reporting, by the second terminal device, the status information or the measurement result to the target device periodically.

7. The method of claim 1, wherein reporting, by the second terminal device, the status information or the measurement result to the target device, comprises:
reporting, by the second terminal device, the status information or the measurement result to the target device in response to a triggering condition, wherein the triggering condition comprises at least one of:
the measurement result obtained by the second terminal device by measuring the sidelink reference signal being a first status, and a duration of the first status exceeding a threshold;
N measurement results consecutively obtained by the second terminal device being all the first status;
the measurement result obtained by the second terminal device by measuring the sidelink reference signal being the first status, and status information reported by the second terminal device last time being a second status;
a timer associated with reporting of the status information or the measurement result expiring; or
a counter associated with the reporting of the status information or the measurement result reaching another threshold.

8. The method of claim 1, wherein reporting, by the second terminal device, the status information or the measurement result to the target device, comprises:
reporting, by the second terminal device, the status information or the measurement result to the target device in response to a variation value exceeding a threshold, wherein the variation value is used for indicating a variation of information determined by the second terminal device by measuring the sidelink reference signal.

9. A terminal device, comprising:
a transceiver;
at least one processor; and
a memory storing computer programs which, when executed by the at least one processor, cause the transceiver to:
receive a sidelink reference signal from another terminal device;
the computer programs, when executed by the at least one processor, cause the at least one processor to:
measure the sidelink reference signal to obtain status information or a measurement result, wherein the status information or the measurement result is used for indicating a status of a sidelink between the terminal device and the another terminal device; and
the computer programs, when executed by the at least one processor, further cause the transceiver to:
report the status information or the measurement result to a target device, wherein the target device comprises at least one of the another terminal device, a network device, or a group header terminal device of a device group comprising the terminal device.

10. The terminal device of claim 9, wherein in case that the another terminal device transmits the sidelink reference signal on at least one carrier or at least one bandwidth part (BWP), the computer programs causing the at least one processor to measure the sidelink reference signal to obtain the status information or the measurement result cause the at least one processor to:
measure the sidelink reference signal transmitted on each carrier of the at least one carrier or on each BWP of the at least one BWP, to obtain the status information or the measurement result.

11. The terminal device of claim 9, wherein the computer programs causing the at least one processor to measure the sidelink reference signal to obtain the status information or the measurement result cause the at least one processor to:
measure the sidelink reference signal and perform filtering processing, to obtain the status information or the measurement result.

12. The terminal device of claim 9, wherein the computer programs, when executed by the at least one processor, further cause the transceiver to:
receive sidelink data transmitted by the another terminal device;
transmit feedback information to the another terminal device in response to the measurement result obtained by measuring the sidelink reference signal being higher than a threshold, wherein the feedback information is used for indicating whether the sidelink data is correctly received by the terminal device; and
refuse to transmit the feedback information to the another terminal device in response to the measurement result obtained by measuring the sidelink reference signal being lower than the threshold.

13. The terminal device of claim 12, wherein the threshold is determined according to service attribute of the sidelink data transmitted between the another terminal device and the terminal device, wherein the service attribute comprises at least one of: a priority, reliability, a time delay, a communication range, a service type, or a logical channel.

14. The terminal device of claim 9, wherein the computer programs causing the transceiver to report the status information or the measurement result to the target device cause the transceiver to:
report the status information or the measurement result to the target device periodically.

15. The terminal device of claim 9, wherein the computer programs causing the transceiver to report the status information or the measurement result to the target device cause the transceiver to:
report the status information or the measurement result to the target device in response to a triggering condition, wherein the triggering condition comprises at least one of:
the measurement result obtained by the terminal device by measuring the sidelink reference signal being a first status, and a duration of the first status exceeding a threshold;
N measurement results consecutively obtained by the terminal device being all the first status;
the measurement result obtained by the terminal device by measuring the sidelink reference signal being the first status, and status information reported by the terminal device last time being a second status;
a timer associated with reporting of the status information or the measurement result expiring; or
a counter associated with the reporting of the status information or the measurement result reaching another threshold.

16. The terminal device of claim 9, wherein the computer programs causing the transceiver to report the status information or the measurement result to the target device cause the transceiver to:
report the status information or the measurement result to the target device in response to a variation value exceeding a threshold, wherein the variation value is used for indicating a variation of information determined by the terminal device by measuring the sidelink reference signal.

17. A non-transitory computer-readable storage medium, being configured to store computer programs;
the computer programs, when executed by a terminal device, cause the terminal device to:
receive a sidelink reference signal from another terminal device;
measure the sidelink reference signal to obtain status information or a measurement result, wherein the status information or the measurement result is used for indicating a status of a sidelink between the another terminal device and the terminal device; and
report the status information or the measurement result to a target device, wherein the target device comprises at least one of the another terminal device, a network device, or a group header terminal device of a device group comprising the terminal device.

18. The non-transitory computer-readable storage medium of claim 17, wherein in case that the another terminal device transmits the sidelink reference signal on at least one carrier or at least one bandwidth part (BWP), the computer programs causing the terminal device to measure the sidelink reference signal to obtain the status information or the measurement result cause the terminal device to:
measure the sidelink reference signal transmitted on each carrier of the at least one carrier or on each BWP of the at least one BWP, to obtain the status information or the measurement result.

19. The non-transitory computer-readable storage medium of claim 17, wherein the computer programs causing the terminal device to measure the sidelink reference signal to obtain the status information or the measurement result cause the terminal device to:
measure the sidelink reference signal and perform filtering processing, to obtain the status information or the measurement result.

20. The non-transitory computer-readable storage medium of claim 17, wherein the computer programs, when executed by the terminal device, further cause the terminal device to:
receive sidelink data transmitted by the another terminal device;
transmit feedback information to the another terminal device in response to the measurement result obtained by measuring the sidelink reference signal being higher than a threshold, wherein the feedback information is used for indicating whether the sidelink data is correctly received by the terminal device; and
refuse to transmit the feedback information to the another terminal device in response to the measurement result obtained by measuring the sidelink reference signal being lower than the threshold.
